(19) United States
(12) Patent Application Publication
(10) Pub. No.: US 2025/0220078 A1
(43) Pub. Date: Jul. 3, 2025

(54) SMARTNIC OFFLOADING BASED REMOTE MEMORY SYSTEM

(71) Applicant: SHANGHAI JIAO TONG UNIVERSITY, Shanghai (CN)

(72) Inventors: Jian LI, Shanghai (CN); Zhanghui YU, Shanghai (CN); Haibing GUAN, Shanghai (CN)

(21) Appl. No.: 19/064,373

(22) Filed: Feb. 26, 2025

Related U.S. Application Data
(63) Continuation-in-part of application No. PCT/CN2024/104879, filed on Jul. 11, 2024.

(30) Foreign Application Priority Data
Jan. 2, 2024 (CN) 202410002124.7

(51) Int. Cl. H04L 67/1097

(52) U.S. Cl. CPC H04L 67/1097

(57) ABSTRACT

A SmartNIC offloading based remote memory system pertains to the field of communication technology and includes a compute node, a SmartNIC and a memory node. The compute node sends a remote memory access request to the SmartNIC. The SmartNIC is used to parse the remote memory access request and access the memory node. The memory node initializes and saves remote memory. The SmartNIC includes a remote memory access request handling module, a data address management module and an RDMA communication front end, and the memory node includes an RDMA communication back end. Use of the remote memory system includes an initialization stage, an application registration stage and a running stage. The system offloads management overhead from the memory node to the SmartNIC, achieving in-network management of remote memory.

### RELATED APPLICATIONS

This application is a continuation-in-part (CIP) application claiming benefit of PCT/CN2024/104879 filed on Jul. 11, 2024, which claims priority to Chinese Patent Application No. 202410002124.7 filed on Jan. 2, 2024, the disclosures of which are incorporated herein in their entirety by reference.

### FIELD OF THE INVENTION

The present invention relates to the field of communication technology, and in particular to a SmartNIC offloading based remote memory system.

### DESCRIPTION OF THE PRIOR ART

In modern data centers, memory is the resources that limit us most, and also the resources that we compete most for. As workloads of memory, such as the storage of machine learning applications and key-value pairs, are gaining increasing popularity, users' demand for memory of computing clusters in data centers grows explosively.

Insufficient memory resources of servers have become a major bottleneck that affects the performance of applications.

One way to overcome this bottleneck is the memory pooling architecture across servers, which converts memory of other servers into remote memory available for use by local applications. In this architecture, a compute node is allowed to access memory at remote memory nodes, meaning that servers are no longer limited to the local memory, but can make use of free memory located elsewhere in the cluster. The rapid development of network performance has brought about the emergence of remote direct memory access (RDMA) technology for solving server-side data processing latency in network transfers. This network communication technology has been widely used in remote memory systems thanks to its high-throughput and low-latency advantages.

Traditional remote memory systems are implemented based on a virtual memory abstraction of the Linux OS kernel. When a desired memory page is absent in local memory, a page fault is triggered to activate a page fault handler to detect whether remote access is needed. If so, the desired memory page is retrieved from a remote memory node and buffered into the local memory through a network transfer, eventually making the data available for use by local applications. However, such remote memory access based on kernel page faults suffers from the following bottlenecks: 1) the page fault handler must enter the kernel space, involving frequent context switches and introducing additional overhead; and 2) the kernel lacks application semantics and the granularity of page retrieval is limited to the kernel's page size (4 KB). As the minimum network transfer size is at least one page, access to finer-granularity objects would incur significant read/write amplification, leading to a waste of network bandwidth.

At present, remote memory access implemented based on a user-space runtime library is a prevailing solution to address the limitations of traditional kernel-mode remote memory systems. This approach is advantageous in allowing applications to use exposed key-value or data-structure interfaces for programming, thereby enabling efficient utilization of application semantics and hence fine-granularity access to remote data at object granularity. This bypasses the high kernel page fault handling overhead, and circumvents read/write amplification. The application-integrated far memory (AIFM) design proposed by Zhenyuan Ruan et al. is described below as a representative example of the mainstream user-space runtime library based remote memory architectures. As shown in FIG. 1, the design is based on a fast-speed, low-overhead, remote-access-supporting pointer abstraction, which exposes data structure programming interface with semantic information transfer capabilities to applications on the compute node side, which are programmed based on a runtime library, allowing the applications to access remote memory at object granularity without resorting to kernel page fault handling. A management unit is deployed at each remote memory node to process remote access requests, and addresses of data corresponding to an object can be identified in a data address management module according to the object's ID, helping achieve object-granularity access to remote memory nodes. Network communication of this design is based on the TCP network protocol stack for user-space DPDK (Data Plane Development Kit) applications and bypasses the kernel, reducing context switches that may be otherwise incurred when the kernel is involved. However, in order to ensure performance, DPDK applications receive packets through polling of threads, which consumes much CPU resources. Fast remote memory (FaRM), another type of architecture, employs one-sided RDMA semantics for communication between compute and memory nodes, but still requires CPU polling of request buffers for data reception at memory nodes.

Many previous studies have demonstrated that, in disaggregated architectures, memory nodes have very limited CPU resources. However, current user-space runtime library based approaches introduce the following two major types of overhead of compute resources at memory nodes:
1. Memory node management overhead: it is necessary for the management unit at each remote memory node to create a dedicated service process for handling remote memory access requests, which consumes CPU resources at memory nodes, introducing computing overhead to memory nodes in addition to memory overhead.
2. Network communication overhead: Although the use of a DPDK- or RDMA-based user-space network protocol stack can bypass the kernel, it generally requires CPU polling, which makes the CPU that provides network services always 100% occupied, incurring huge overhead of limited CPU resources at memory nodes.

As can be seen, the existing user-space runtime library based remote memory systems fail to support complete disaggregation of memory and computing. The recently emerging SmartNICs has been extensively used in data centers. For example, in previous studies, system-on-a-chips (SoCs) on SmartNICs have been investigated to accelerate distributed transactions.

Therefore, those skilled in the art are directing their effort toward developing a SmartNIC offloading based remote memory system, which utilizes an SoC on the SmartNIC to offload management of remote memory nodes and directly read memory of the memory nodes through one-sided RDMA, thereby achieving in-network remote memory management and oblivious access to the memory nodes.

### SUMMARY OF THE INVENTION

In view of the above-described disadvantages of the prior art, the problem sought to be solved by the present invention is CPU computing and management overhead introduced by the use of management units and a network protocol stack at memory nodes.

In order to solve this problem, the present invention provides a SmartNIC offloading based remote memory system, characterized in comprising a compute node, a SmartNIC and a memory node, wherein the compute node sends a remote memory access request to the SmartNIC; the SmartNIC is used to parse the remote memory access request and access the memory node; the memory node is used to initialize and save remote memory; the SmartNIC comprises a remote memory access request handling module, a data address management module and an RDMA communication front end, and the memory node comprises an RDMA communication back end; and the stage of use of the remote memory system comprises an initialization stage, an application registration stage and a running stage.

Additionally, the RDMA communication back end may be used to specify a size of a memory region and send a virtual base address of the memory region and a remote key to the SmartNIC, during initialization.

Additionally, the remote memory access request handling module may comprise a two-sided RDMA communication function, request data parsing function and a memory node interaction function, wherein the data address management module is used to manage a memory region offset mapping table, and the RDMA communication front end is used to store the virtual base address, the remote key and outbound and completion queues for RDMA communication with the memory region.

Additionally, the initialization stage may comprise:
initiating a connection request for RDMA initialization to the RDMA communication back end, establishing a connection with an RDMA queue pair, and creating a completion queue corresponding to the queue pair and a buffer for receiving data transmitted from the memory node through the queue pair, by the RDMA
registering a memory region according to a size of the connection request for RDMA initialization, by the memory node;
sending the virtual base address and remote key of the registered memory region to a buffer on the SmartNIC through the queue pair, by the memory node; and
storing the virtual base address and remote key in the RDMA communication front end, by the SmartNIC.

Additionally, the application registration stage may comprise:
activating an application at the compute node, which initiates a connection with the SmartNIC for RDMA communication and then initiates a registration request informing the SmartNIC of a desired remote memory size;
receiving the registration request, allocating and recording a starting location of a remote memory region available for use by the application, creating an object ID to memory region offset mapping table for the application in the data address management module and recording any subsequently use of data in the remote memory space in the memory region offset mapping table, by the SmartNIC; and
returning an acknowledgement, notifying the application at the compute node that it can continue running, after the registration is completed.

Additionally, the running stage may comprise:
Step 1: initiating a two-sided RDMA remote memory read/write request by a thread run by the application at the compute node;
Step 2: determining a virtual address in the memory node through address translation, after receiving the request, by the SmartNIC;
Step 3: initiating a one-sided RDMA read/write operation on the memory node, by the SmartNIC, wherein the memory node is unaware of this process; and
Step 4: retrieving completion results by polling the completion queue and returning read/write operation results to the compute node through a two-sided RDMA request, by the SmartNIC.

Additionally, Step 1 may further comprise:
sending the request and simultaneously dispatching a buffer for receiving the results by the compute node, wherein data requested comprises an operation type, an object ID and a data size, and further comprises a data field to be written, if the operation type indicates a write request.

Additionally, Step 2 may further comprise:
Step 2.1: placing the request sent from the compute node into a request buffer for the remote memory access request handling module, receiving the request from the compute node by the remote memory access request handling module through polling a request notification queue, and then notifying a thread in a thread pool to handle the request in the buffer;
Step 2.2: parsing the data requested and using the data address management module to search for a memory region offset corresponding to the object ID for an object ID field, by the remote memory access request handling module;
Step 2.3: handing the memory region offset and the data requested over to the RDMA communication front end, by the remote memory access request handling module; and
Step 2.4: determining the virtual address where the object is located, based on a virtual base address and the memory region offset, by the RDMA communication front end.

Additionally, Step 3 may further comprise:
Step 3.1: initiating a one-sided RDMA request through the virtual address and filling it in an outbound queue, by the RDMA communication front end; and
Step 3.2: performing read/write operations sequentially at locations, which correspond to virtual addresses in the memory node, according to an order in the outbound queue and after completion, filling the completion results in the completion queue according to the order of sending, by an RDMA hardware device.

Additionally, Step 4 may further comprise:
polling the completion queue and returning the results of each completed request to the compute node using two-sided RDMA SEND semantics, by the RDMA communication front end, wherein for a write request, the SmartNIC needs to increase or modify the memory region offset mapping table in the data address management module after completion, and for a read request, the SmartNIC needs to return the content of read data to the compute node.

Compared with the prior art, the present invention provides at least the following benefits:
1. It utilizes a SmartNIC to offload management of remote memory based on a user-space runtime library, achieving in-network management of the remote memory. The compute node communicates with only the SmartNIC, and an SoC on the SmartNIC parses remote requests from the compute node and manages mappings of object IDs to physical addresses of data. The remote memory system can be used to effectively reduce CPU computing and management overhead of the memory node. Moreover, the SoC on the SmartNIC has low power consumption, and implementing remote memory management by the SoC can effectively reduce electricity and other expenses during operation.
2. It enables oblivious access to the memory node. As the SmartNIC is responsible for performing data read/write operations on the memory node through one-sided RDMA, overhead associated with communication with the compute node is all transferred to the SmartNIC. In this process, the memory node is totally passive, and the CPU at the memory node is not involved in such read/write operations at all. Therefore, overhead of the CPU resources is almost zero during operation.

For a full understanding of the objects, features and effects of the present application, the concept, structural details and resulting technical effects will be further described with reference to the accompanying drawings.

### BRIEF DESCRIPTION OF THE DRAWINGS

FIG. 1 is a schematic diagram showing the architecture of a conventional system.

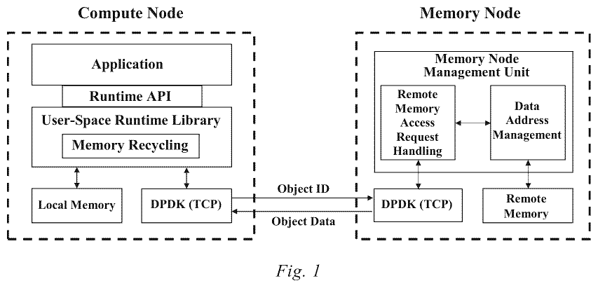

FIG. 2 is a schematic diagram showing the architecture of a system according to a preferred embodiment of the present invention.

FIG. 3 schematically illustrates stages of use of the system according to a preferred embodiment of the present invention.

### DETAILED DESCRIPTION OF THE PREFERRED EMBODIMENTS

A few preferred embodiments of the present application are described below with reference to the drawings accompanying this specification so that the techniques disclosed herein become more apparent and better understood. The present application may be embodied in many different forms, and its scope sought to be protected hereby is not limited only to the embodiments disclosed herein.

A SmartNIC combines network and compute resources within a single card, providing higher network performance at lower cost, compared to ordinary CPUs. The present invention adds a SmartNIC to a memory node, offloading management overhead of the memory node to an SoC on the SmartNIC and achieving centralized remote memory management. The SmartNIC receives and handles remote memory access requests, while the memory node is only responsible for running a resident process for initializing and saving all remote memory. During running of the remote memory, the SoC on the SmartNIC sends one-sided RDMA read/write requests to the memory node. The memory node acts like a passive receiver, and the SmartNIC completes the handling of the requests, without needing the CPU to do anything to the requests.

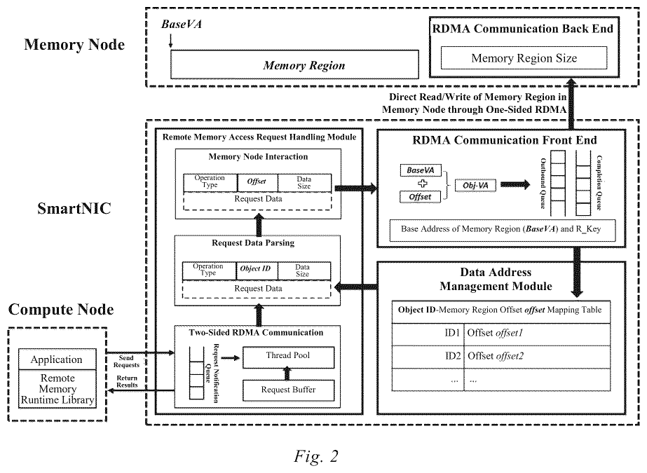

Embodiments of the present invention provide a SmartNIC offloading based remote memory system, which, as shown in FIG. 2, includes a compute node, a SmartNIC and a memory node. The compute node adopts the conventional AIFM design, which requires associated applications to be programmed based on a user-space runtime library provided by the AIFM at the compute node. During use of the remote memory, the compute node sends remote memory access requests to the SmartNIC. A RDMA communication back end deployed at the memory node is responsible for specifying a size of a memory region at a base address denoted as BaseVA. On the SmartNIC are deployed a remote memory access request handling module, a data address management module and an RDMA communication front end.

Main components of the remote memory access request handling module are a two-sided RDMA communication function, a request data parsing function and a memory node interaction function. The data address management module is used to manage an object ID-memory region offset mapping table. The RDMA communication front end stores BaseVA of memory regions in the memory node, a remote key R_Key necessary for access and outbound and completion queues for RDMA communication with the memory regions.

A process performed after a remote memory access request is sent to the SmartNIC is as follows:
In Step a, the compute node sends the request to the SmartNIC using RDMA SEND semantics ibv_post_send and dispatches a buffer for receiving results using RECV semantics.
In Step b, the remote memory access request handling module uses the two-sided RDMA communication function to place the request into the request buffer that has been dispatched in advance using RDMA RECV semantics, and an SoC thread receives the request from the compute node through polling a request notification queue using ibv_poll_cq and then notifies a thread in a thread pool to handle the request in the buffer.
In Step c, the remote memory access request handling module parses the data request, which is divided into multiple fields including operation type (read/write), object ID and data size, as well as a data field to be written in case of a write request, using the request data parsing function, and the data address management module looks up a memory region offset corresponding to the object ID for the object ID field. This is a crucial process for translating a local object into a remote memory address.
In Step d, the remote memory access request handling module hands the offset and the data requested over to the RDMA communication front end using the memory node interaction function.
In Step e, the RDMA communication front end determines a virtual address Obj-VA of the object based on its BaseVA and offset, initiates a one-sided RDMA request through the virtual address using ibv_post_send, and fills the request in an outbound queue.
In Step f, an RDMA hardware device performs read/write operations sequentially at locations, which corresponds to virtual addresses Obj-VA of requests in the outbound queue, according to an order in the outbound queue. This process does not involve the memory node and results of the completed operations are filled in a completion queue also according to the order of the requests in the outbound queue.
In Step g, the RDMA communication front end polls the completion queue and returns the results of the requests to the compute node also using two-sided RDMA SEND semantics. For each write request, information indicating successful handling is returned to the compute node, and information of the mapping table in the data address management module is increased or modified. For each read request, the content of read data is also returned to the compute node.

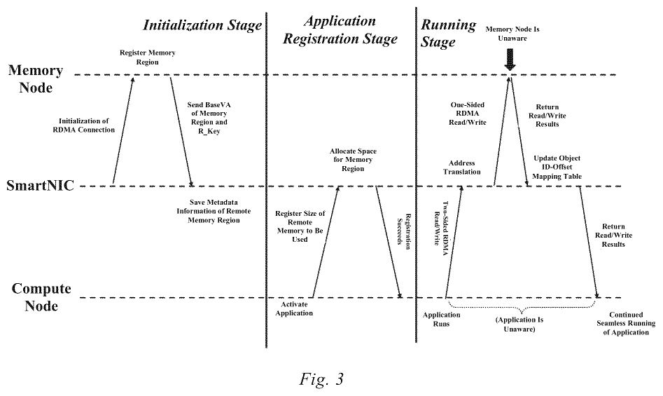

According to embodiments of the present invention, transparent RDMA of the SmartNIC to memory at the memory node can be achieved using the RDMA semantics API for general purpose according to a process shown in FIG. 3. This process can be divided into three stages: initialization, application registration and running. Steps in these stages are detailed below.
1. Initialization Stage
In Step 1.1, the RDMA communication front end on the SmartNIC initiates a connection request for RDMA initialization to the RDMA communication back end at the memory node, establishes a connection with an RDMA queue pair (QP), and creates a completion queue (CQ) corresponding to the QP and a buffer for receiving data transmitted from the memory node through the QP.
In Step 1.2, the memory node registers an RDMA memory region (MR) based on a size of the request using the ibv_reg_mr( ) API.
In Step 1.3, the memory node sends a virtual base address BaseVA of the registered memory region and a remote key R_Key necessary for remote access to the memory region to the buffer on the SmartNIC through the QP. This process can be accomplished using a two-sided RDMA operation.
In Step 1.4, the SmartNIC retrieves BaseVA and R_Key from the buffer and saves them in the RDMA communication front end. These two critical pieces of information are necessary for the subsequent one-sided RDMA access.
2. Application Registration Stage
In Step 2.1, an application at the compute node initiates a connection with the SmartNIC for RDMA communication and then initiates a registration request, which notifies the SmartNIC of a required remote memory size.
In Step 2.2, the SmartNIC receives the registration request, allocates and records a starting location of a remote memory region available for use by the application and creates an object ID to memory region offset mapping table for the application in the data address management module. Any subsequent use of data in the remote memory space is recorded in the table.
In Step 2.3, an acknowledgement is returned to the application, notifying that it can continue running, after the registration is completed.
3. Running Stage
In Step 3.1, a thread run by the application initiates a two-sided RDMA remote memory read/write request.
In Step 3.2, after receiving the request, the SmartNIC performs an address translation operation as described above in connection with Step c to determine a virtual address in the memory node.
In Step 3.3, the SmartNIC initiates a one-sided RDMA read/write operation on the memory node. The memory node is unaware of this process.
In Step 3.4, the SmartNIC retrieves results of the completed read/write operation by polling the completion queue (CQ).
In Step 3.5, in case of a write operation, after the completion, the SmartNIC updates the mapping table in the data address management module.
In Step 3.6, the SmartNIC returns the results of the read/write operation to the compute node through a two-sided RDMA request.
In Step 3.7, the thread of the application continues running seamlessly, and the entire running process is accomplished by the user-space runtime library that is provided by the AIFM at the compute node.

Although a few preferred specific embodiments of the present application have been described in detail above, it will be understood that those of ordinary skill in the art can make various modifications and changes thereto based on the concept of the present application without exerting any creative effort. Accordingly, all variant embodiments that can be obtained by those skilled in the art through logical analysis, inference or limited experimentation in accordance with the concept of the present invention on the basis of the prior art are intended to fall within the scope as defined by the appended claims.

1. A Smart Network Interface Card (SmartNIC) offloading based remote memory system comprising a compute node, a SmartNIC and a memory node, wherein the compute node sends a remote memory access request to the SmartNIC; the SmartNIC is used to parse the remote memory access request and access the memory node; the memory node is used to initialize and save remote memory; the SmartNIC comprises a remote memory access request handling module, a data address management module and a remote direct memory access (RDMA) communication front end, and the memory node comprises an RDMA communication back end; and the stage of use of the remote memory system comprises an initialization stage, an application registration stage and a running stage.

2. The SmartNIC offloading based remote memory system of claim 1, characterized in that the RDMA communication back end is used to specify a size of a memory region and send a virtual base address of the memory region and a remote key to the SmartNIC, during initialization.

3. The SmartNIC offloading based remote memory system of claim 2, characterized in that the remote memory access request handling module comprises a two-sided RDMA communication function, a request data parsing function and a memory node interaction function, wherein the data address management module is used to manage a memory region offset mapping table, and the RDMA communication front end is used to store the virtual base address, the remote key and outbound and completion queues for RDMA communication with the memory region.

4. The SmartNIC offloading based remote memory system of claim 3, characterized in that the initialization stage comprises:
initiating a connection request for RDMA initialization to the RDMA communication back end, establishing a connection with an RDMA queue pair, and creating a completion queue corresponding to the queue pair and a buffer for receiving data transmitted from the memory node through the queue pair, by the RDMA communication front end;
registering a memory region according to a size of the connection request for RDMA initialization, by the memory node;
sending the virtual base address and remote key of the registered memory region to a buffer on the SmartNIC through the queue pair, by the memory node; and
storing the virtual base address and remote key in the RDMA communication front end, by the SmartNIC.

5. The SmartNIC offloading based remote memory system of claim 4, characterized in that the application registration stage comprises:
activating an application at the compute node, which initiates a connection with the SmartNIC for RDMA communication and then initiates a registration request informing the SmartNIC of a desired remote memory size;
receiving the registration request, allocating and recording a starting location of a remote memory region available for use by the application, creating an object ID to memory region offset mapping table for the application in the data address management module and recording any subsequently use of data in the remote memory space in the memory region offset mapping table, by the SmartNIC; and
returning an acknowledgement, notifying the application at the compute node that it can continue running, after the registration is completed.

6. The SmartNIC offloading based remote memory system of claim 5, characterized in that the running stage comprises:
Step 1: initiating a two-sided RDMA remote memory read/write request by a thread run by the application at the compute node;
Step 2: determining a virtual address in the memory node through address translation after receiving the request, by the SmartNIC;
Step 3: initiating a one-sided RDMA read/write operation on the memory node, by the SmartNIC; and
Step 4: retrieving completion results by polling the completion queue and returning read/write operation results to the compute node through a two-sided RDMA request, by the SmartNIC.

7. The SmartNIC offloading based remote memory system of claim 6, characterized in that Step 1 further comprises:
sending the request and simultaneously dispatching a buffer for receiving the results by the compute node, wherein data requested comprises an operation type, an object ID and a data size, and further comprises a data field to be written, if the operation type indicates a write request.

8. The SmartNIC offloading based remote memory system of claim 7, characterized in that Step 2 further comprises:
Step 2.1: placing the request sent from the compute node into a request buffer for the remote memory access request handling module, receiving the request from the compute node by the remote memory access request handling module through polling a request notification queue, and then notifying a thread in a thread pool to handle the request in the buffer;
Step 2.2: parsing the data requested and using the data address management module to search for a memory region offset corresponding to the object ID for an object ID field, by the remote memory access request handling module;
Step 2.3: handing the memory region offset and the data requested over to the RDMA communication front end, by the remote memory access request handling module; and
Step 2.4: determining the virtual address where the object is located, based on a virtual base address and the memory region offset, by the RDMA communication front end.

9. The SmartNIC offloading based remote memory system of claim 8, characterized in that Step 3 further comprises:
Step 3.1: initiating a one-sided RDMA request through the virtual address and filling it in an outbound queue, by the RDMA communication front end; and
Step 3.2: performing read/write operations sequentially at locations, which correspond to virtual addresses in the memory node, according to an order in the outbound queue and after completion, filling the completion results in the completion queue according to the order of sending, by an RDMA hardware device.

10. The SmartNIC offloading based remote memory system of claim 9, characterized in that Step 4 further comprises:
polling the completion queue and returning the results of each completed request to the compute node using two-sided RDMA SEND semantics, by the RDMA communication front end, wherein for a write request, the SmartNIC needs to increase or modify the memory region offset mapping table in the data address management module after completion, and for a read request, the SmartNIC needs to return the content of read data to the compute node.
